(19) United States
(12) Patent Application Publication
(10) Pub. No.: US 2014/0310716 A1
(43) Pub. Date: Oct. 16, 2014

(54) COMMUNICATION CONTROL METHOD AND RECORDING

(71) Applicant: Ayumi Ono, Tokyo (JP)

(72) Inventor: Ayumi Ono, Tokyo (JP)

(73) Assignee: RICOH COMPANY, LTD., Tokyo (JP)

(21) Appl. No.: 14/247,996

(22) Filed: Apr. 8, 2014

(30) Foreign Application Priority Data
Apr. 15, 2013 (JP) 2013-084731

(51) Int. Cl. G06F 9/48

(52) U.S. Cl. CPC G06F 9/48
USPC 718/102

(57) ABSTRACT

A non-transitory computer-readable recording medium stores a program, which when processed by a processor, causes a computer to serve as components of the computer. The components include a recording unit to record information indicating whether a communication requesting a first process is being performed in a transmitting source, the transmitting source performing the communication requesting the first process that takes a long time to complete and a communication requesting a second process that takes a time shorter than that of the first process, and a simultaneous connection control unit to control a number of communications requesting the first process by referring to the information stored in the recording unit such that at least one communication requesting the second process is performed in the transmitting source when a number of simultaneously occurring communications allowed to be performed is restricted in the transmitting source of the communications and a receiving destination.

### CROSS-REFERENCE TO RELATED APPLICATION

This patent application is based on and claims priority pursuant to 35 U.S.C. §119(a) to Japanese Patent Application No. 2013-084731, filed on Apr. 15, 2013, in the Japan Patent Office, the entire disclosure of which is hereby incorporated by reference herein.

### BACKGROUND OF THE INVENTION

1. Field of the Invention

The disclosures herein generally relate to a communication control method and a recording medium.

2. Description of the Related Art

There is known in the related art an independent access concentration relaxing system capable of relaxing the concentration of accesses from user terminals to an end server by accurately controlling timing for each of the user terminals to access the end server based on a service time of the end server (e.g., Patent Document 1).

In the communications performed between modules, there is a case where the number of communications (i.e., the number of communication ports) may be limited. However, when the number of communication ports is limited, and the number of communications requesting a process requiring a longer time to complete that is performed between the modules exceeds the number of communication ports, a subsequent process may fail to be performed accurately.

### RELATED ART DOCUMENTS

### Patent Document

Patent Document 1: Japanese Laid-open Patent Publication No. 2010-231353

### SUMMARY OF THE INVENTION

Accordingly, it is a general object in one embodiment of the present invention to provide a communication control method capable of restricting a number of simultaneously occurring communications requesting processes that take a long time to complete that substantially obviates one or more problems caused by the limitations and disadvantages of the related art.

According to one aspect of the embodiment, there is provided a non-transitory recording medium storing a program, which when processed by a processor, causes a computer to serve as components of the computer. The components include a recording unit configured to record information indicating whether a communication requesting a first process is being performed in a transmitting source, the transmitting source performing the communication requesting the first process that takes a long time to complete and a communication requesting a second process that takes a time shorter than that of the first process; and a simultaneous connection control unit configured to control a number of communications requesting the first process by referring to the information stored in the recording unit such that at least one communication requesting the second process is performed in the transmitting source when a number of simultaneously occurring communications allowed to be performed is restricted in the transmitting source of the communications and a receiving destination.

The object and advantages of the invention will be realized and attained by means of the elements and combinations particularly pointed out in the claims.

It is to be understood that both the foregoing general description and the following detailed description are exemplary and explanatory and are not restrictive of the invention as claimed.

Other objects and further features of the present invention will be apparent from the following detailed description when read in conjunction with the accompanying drawings.

### BRIEF DESCRIPTION OF THE DRAWINGS

FIG. 1 is a hardware configuration diagram illustrating an example of a computer system;

FIG. 2 is a process block diagram illustrating an example of the computer system on which a GUI application is activated;

FIG. 3 is a sequence diagram illustrating an example of a communication performed between modules;

FIG. 4 is a diagram illustrating an example of a simultaneous connection control process;

FIG. 5 is a diagram illustrating an example of presence or absence of the simultaneous connection control process being determined according to types of communications;

FIG. 6 is a diagram illustrating another example of presence or absence of the simultaneous connection control process being determined according to types of communications;

FIG. 7 is a diagram illustrating another example of presence or absence of the simultaneous connection control process being determined according to types of communications;

FIG. 8 is a process block diagram illustrating examples of a UI module and a service module;

FIG. 9 is a flowchart illustrating an example of a simultaneous connection control process; and

FIG. 10 is a sequence diagram illustrating an example of a simultaneous connection control process.

### DESCRIPTION OF THE PREFERRED EMBODIMENTS

In the following, a description will be given of embodiments of the present invention with reference to the accompanying drawings. A GUI (graphical user interface) application program may be used for facilitating comprehension of the embodiments. However, the embodiments are not limited to those employing the GUI application program.

### First Embodiment

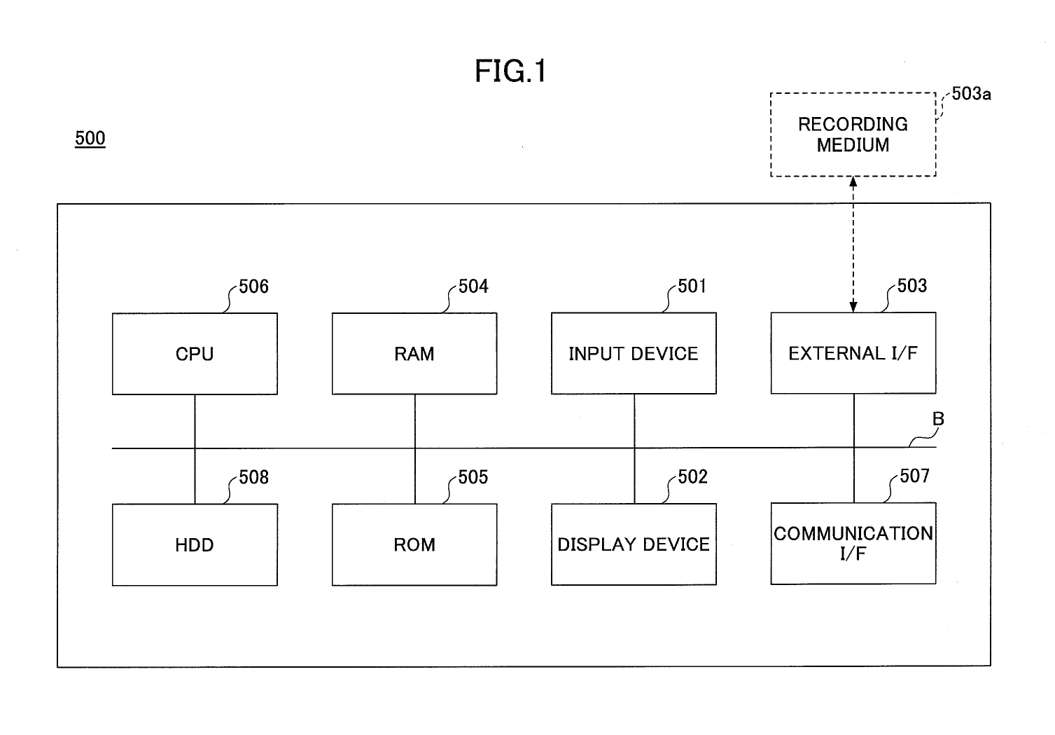

The GUI application program may operate on a computer system having a hardware configuration illustrated in FIG. 1.

FIG. 1 is a hardware configuration diagram illustrating an example of a computer system 500. The computer system 500 includes an input device 501, a display device 502, an external I/F 503, a RAM 504, a ROM 505, a CPU 506, a communication I/F 507, and an HDD 508, which are mutually connected via a bus B.

The input device 501 includes a keyboard, a mouse, a touch panel and the like that are used by a user to input various types of operations signals. The display device 502 includes a display and the like, and is configured to display processed results produced by the computer system 500.

The communication I/F 507 serves as an interface configured to connect the computer system 500 to a not-illustrated network. Hence, the computer system 500 may be able to perform data communications via the communication I/F 507.

The HDD (hard disk drive) 508 is a nonvolatile storage device configured to store programs or data. Examples of such programs or data stored in the HDD 508 may include an OS (operating system) serving as basic software configured to control the overall computer system 500, or application software that provides various functions on the OS. The HDD 508 is configured to manage the stored programs or data by a predetermined file system and/or a DB (database).

The external I/F 503 is configured to serve as an interface between an external device and the computer system 500. An example of the external device may include a recording medium 503a, and the like. Hence, the computer system 500 may be able to read data from or write data onto the recording medium 503a via the external I/F 503.

Examples of the recording medium 503a include a flexible disk, a CD (compact disk), a DVD (digital versatile disk), and the like. In addition, examples of the recording medium 503a include an SD (secure digital) memory card, a USB (universal serial bus) memory, and the like.

The ROM (read only memory) 505 is nonvolatile semiconductor memory (a nonvolatile storage device) configured to retain programs or data when the power is switched off. The ROM 505 is configured to store programs or data utilized for setting BIOS (basic input/output system), an OS, and a network.

The RAM (random access memory) 504 is volatile semiconductor memory (a volatile storage device) configured to temporarily retain programs or data. The CPU (central processing unit) 506 may be a processor device that is configured to implement overall control of the computer system 500 or functions of the computer system 500. The overall control or functions may be implemented by reading programs or data from the storage device, such as the ROM 505 and the HDD 508, onto the RAM 504, and executing the read programs or executing processes on the read data.

The later-described various types of processes may be implemented by causing the GUI application program (hereinafter simply referred to as a “GUI application”) to operate on the hardware configuration of the computer system 500.

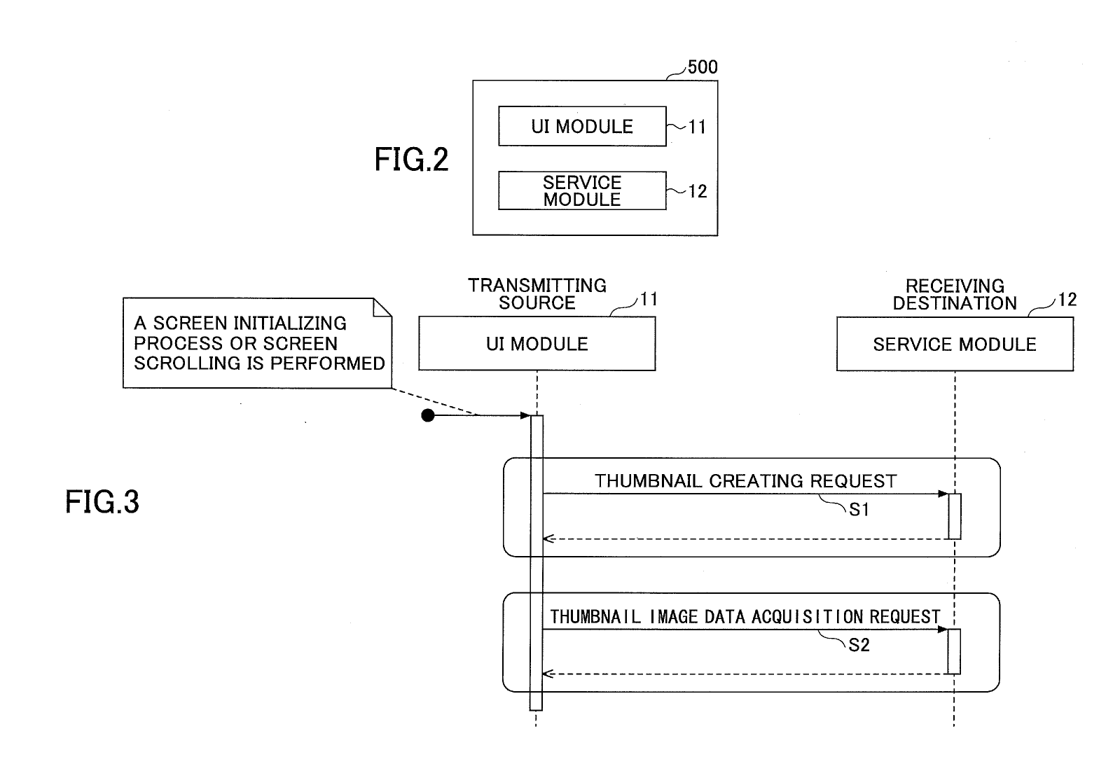

The computer system 500 may, for example, implement a process block illustrated in FIG. 2 by the GUI application. FIG. 2 is a process block diagram illustrating an example of the computer system 500 on which the GUI application is activated.

The computer system 500 of FIG. 1 may implement a UI module 11 and a service module 12 by executing the GUI application. Note that illustration of unnecessary parts of processes is omitted from the process block diagram of FIG. 2. The UI module 11 and the service module 12 are examples of modules between which communications are mutually performed.

The UI module 11 is configured to display setting items and thumbnails on a screen, and perform a process to request the service module 12 to reflect the set results. The service module 12 is configured to manage setting items that are unable to be set simultaneously or inputting or outputting of files as internal processes other than the displaying process on the screen.

Note that communications such as the HTTP (Hypertext Transfer Protocol) communication may be generated for transmitting and receiving a request for performing a process between the UI module 11 and the service module 12 or a request for reporting a processed result. Note also that it is assumed that the number of communication ports in the UI module 11 and the service module 12 is limited to two.

The number of communication ports is limited, for example, due to the restriction on the communication component (e.g., Winlnet) side. The Winlnet is one of components incorporated in Windows (registered trademark), and is used as a communications component for allowing a program to perform communications such as the HTTP communication.

FIG. 3 is a sequence diagram illustrating an example of a communication performed between modules. The communication illustrated in FIG. 3 is a process necessary for displaying a thumbnail by the GUI application. In step S1, the UI module 11 transmits a thumbnail creating request to the service module 12 when a screen initializing process or screen scrolling is performed. Likewise, in step S2, the UI module 11 transmits an image data acquisition request to the service module 12.

The two types of communications illustrated in steps S1 and S2 are examples of communications that take a long time to complete. The GUI application of the embodiment is configured to perform a later-described simultaneous connection control process with respect to communications that take a long time to complete, such as a thumbnail creating request and an image data acquisition request.

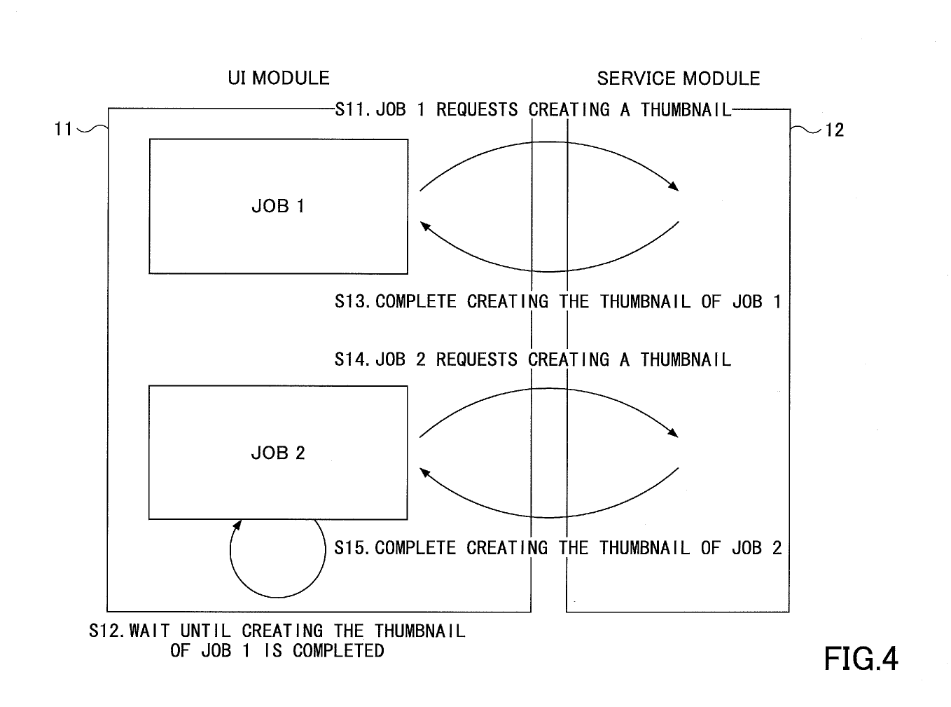

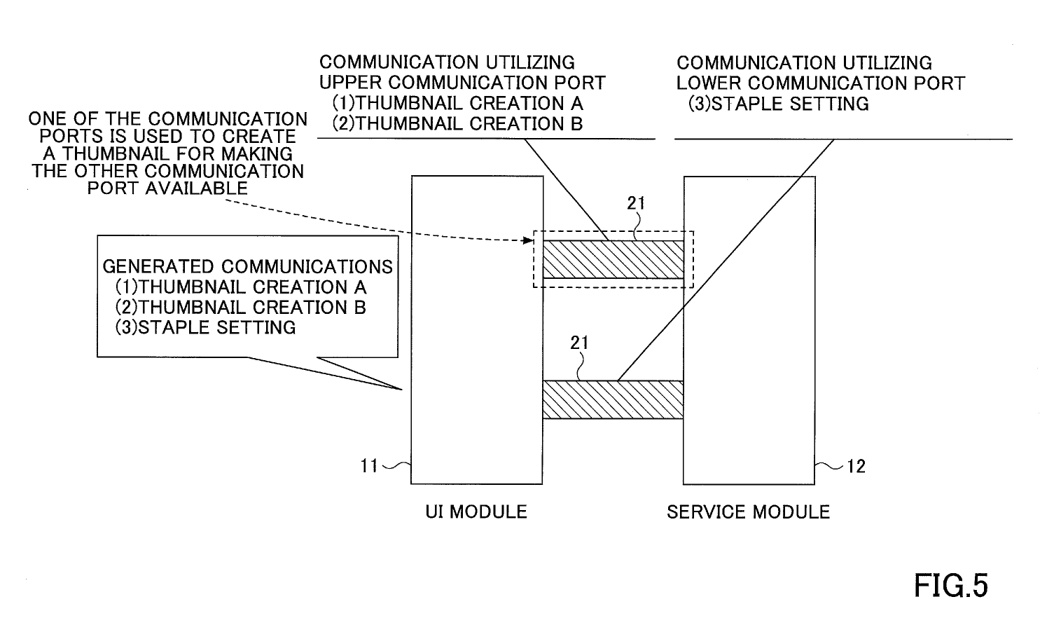

FIG. 4 is a diagram illustrating an example of a simultaneous connection control process. FIG. 4 illustrates a process in which the simultaneous connection control process is performed on two jobs (job 1 and job 2) assumed in the GUI application. In FIG. 4, a job represents a file configured to store a document used in the GUI application or edited contents of the document. FIG. 4 illustrates a case where after the job 1 transmits a thumbnail creating request, the job 2 needs to transmit a thumbnail creating request before creation of the thumbnail requested by the job 1 is completed.

In step S11, the UI module 11 executes a communication with the service module 12 for transmitting the thumbnail creating request of the job 1. In step S12, the UI module 11 needs to transmit the thumbnail creating request of the job 2. However, the UI module 11 waits for a predetermined time (e.g., 1 ms) without performing the communication to transmit the thumbnail creating request of the job 2 because the transmission of the thumbnail creating request of the job 1 is yet to be completed.

Note that the UI module 11 may wait for another predetermined time when the transmission of the thumbnail creating request of the job 1 is yet to be completed. The simultaneous connection control process is performed in step S12. In step S13, the service module 12 completes creating the thumbnail of the job 1. The service module 12 reports a result of the completed thumbnail of the job 1 to the UI module 11.

In step S14, the UI module 11 executes a communication with the service module 12 for transmitting the thumbnail creating request of the job 2. In step S15, the service module 12 completes creating the thumbnail of the job 2. The service module 12 reports a result of the completed thumbnail of the job 2 to the UI module 11.

FIG. 5 is a diagram illustrating an example of presence or absence of the simultaneous connection control process according to types of communications. In FIG. 5, shaded parts visually represent communication ports 21 for performing communications between the UI module 11 and the service module 12. In the example of FIG. 5, the simultaneous connection control process is performed via the upper communication port 21. However, the simultaneous connection control process may be performed via any one of the upper communication port 21 and the lower communication port 21.

The communication requesting a process that takes a long time to complete (e.g., a process necessary for displaying a thumbnail) is performed via the upper communication port 21. Note that the simultaneous connection control process is performed via the upper communication port 21 in this example. By contrast, the communication requesting a process that does not take a long time to complete (e.g., a process for performing a staple setting) is performed via the lower communication port 21. Note that the simultaneous connection control process is not performed via the lower communication port 21 in this example.

In FIG. 5, it is assumed that a thumbnail creating request A, a thumbnail creating request B, and a staple setting request are generated between the UI module 11 and the service module 12. The thumbnail creating request A and the thumbnail creating request B are communicated via the upper communication port 21. Note that the simultaneous connection control process is performed via the upper communication port 21. By contrast, the staple setting request is communicated via the lower communication port 21. Note that the simultaneous connection control process is not performed via the lower communication port 21.

Hence, based on the assumption where a communication of a process that does not take a long time to complete is generated, the UI module 11 performs the communications of the processes that take a long time to complete via another communication port (i.e., the upper communication port 21 in this example) 21 in order to make at least one communication port (i.e., the lower communication port 21 in this example) 21 available.

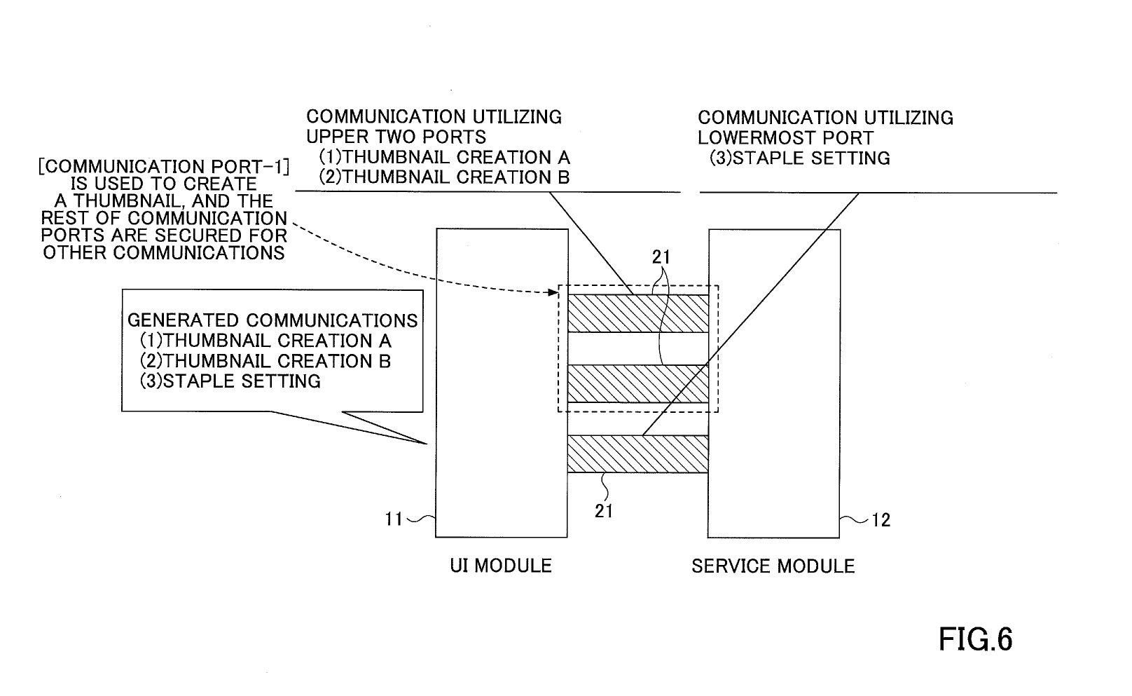

FIG. 6 is a diagram illustrating another example of presence or absence of the simultaneous connection control process according to types of communications. In FIG. 6, shaded parts visually represent the communication ports 21 for performing communications between the UI module 11 and the service module 12. In the example of FIG. 6, the simultaneous connection control process is performed via upper two communication ports 21. However, the simultaneous connection control process may be performed via any two of the three communication ports 21.

Note that FIG. 6 illustrates the example where the number of the communication ports is three; however, the number of the communication ports may be four or more. In a case where the number of the communication ports is four or more, the number of communication ports 21 via which the simultaneous connection control process is performed may be computed by subtracting one from the number of communication ports 21.

The communications for requesting processes that take a long time to complete are performed via the upper two communication ports 21 via which the simultaneous connection control process is performed. By contrast, the communication for requesting a process that does not a long time to complete is performed via a lower one communication port 21 via which the simultaneous connection control process is not performed.

In FIG. 6, it is assumed that a thumbnail creating request A, a thumbnail creating request B, and a staple setting request are generated between the UI module 11 and the service module 12. The thumbnail creating request A and the thumbnail creating request B are communicated via upper two communication ports 21. Note that the simultaneous connection control process is performed via the upper two communication ports 21. By contrast, the staple setting request is communicated via the lower one communication port 21. Note that the simultaneous connection control process is not performed via the lower communication port 21.

Hence, based on the assumption where a communication of a process that does not take a long time to complete is generated, the UI module 11 performs the communications of the processes that take a long time to complete via the number of communication ports from which one is subtracted in order to make at least one communication port (i.e., the lower communication port 21 in this example) 21 available.

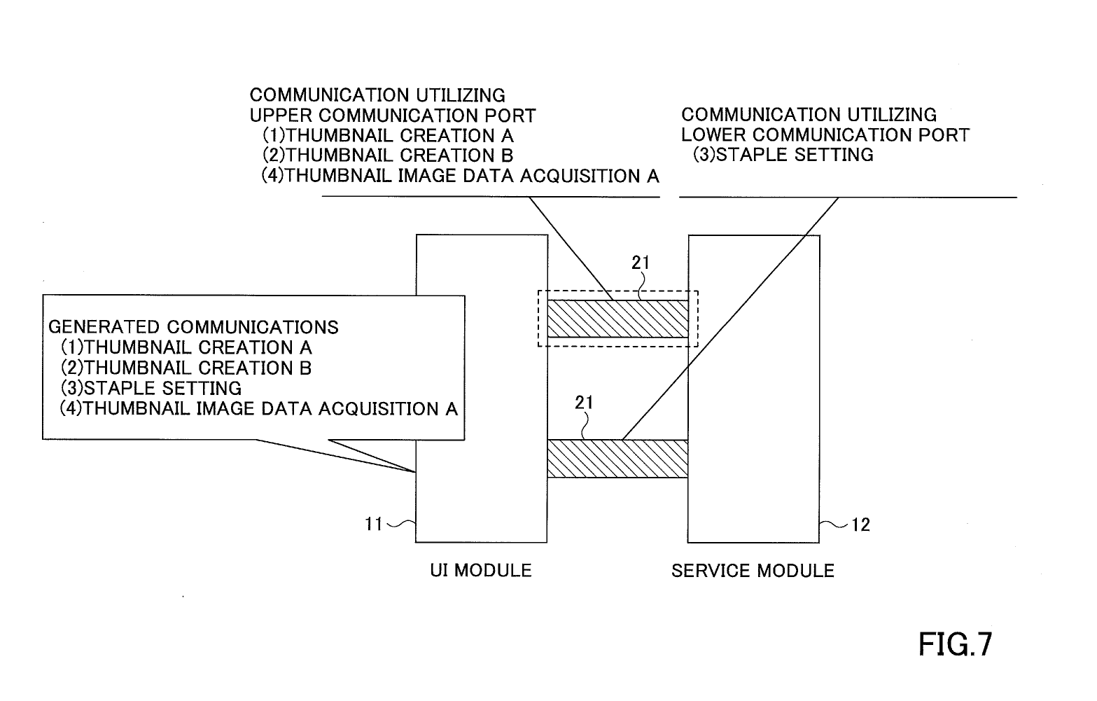

FIG. 7 is a diagram illustrating another example of presence or absence of the simultaneous connection control process according to types of communications. In FIG. 7, shaded parts visually represent the communication ports 21 for performing communications between the UI module 11 and the service module 12. In the example of FIG. 7, the simultaneous connection control process is performed via the upper communication port 21. However, the simultaneous connection control process may be performed via any one of the upper communication port 21 and the lower communication port 21.

The communications requesting the processes that take a long time to complete (e.g., a thumbnail creating process necessary for displaying a thumbnail and a thumbnail image data acquisition process) are performed via the upper communication port 21. Note that the simultaneous connection control process is performed via the upper communication port 21. By contrast, the communication requesting a process that does not take a long time to complete (e.g., a process for performing a staple setting) is performed via the lower communication port 21. Note that the simultaneous connection control process is not performed via the lower communication port 21.

In FIG. 7, it is assumed that a thumbnail creating request A, a thumbnail creating request B, a staple setting request, and a thumbnail image data acquisition request A are generated between the UI module 11 and the service module 12. The thumbnail creating request A, the thumbnail creating request B, and the thumbnail image data acquisition request A are communicated via the upper communication port 21. Note that the simultaneous connection control process is performed via the upper communication port 21. By contrast, the staple setting request is communicated via the lower communication port 21. Note that the simultaneous connection control process is not performed via the lower communication port 21.

Hence, based on the assumption where a communication of a process that does not take a long time to complete is generated, the UI module 11 performs the communications of the processes that take a long time to complete via another communication port (i.e., the upper communication port 21 in this example) 21 in order to make at least one communication port (i.e., the lower communication port 21 in this example) 21 available.

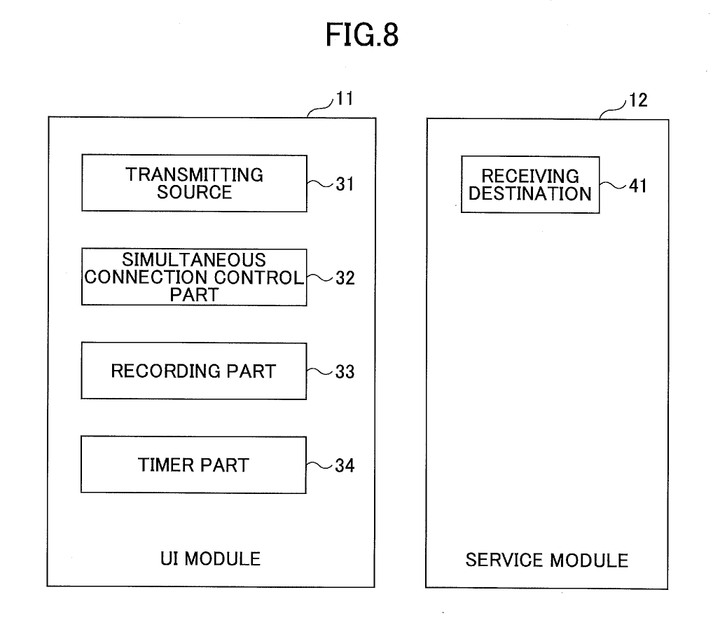

FIG. 8 is a process block diagram illustrating examples of the UI module and the service module. As illustrated in FIG. 8, the UI module 11 is configured to include a transmitting source 31, a simultaneous connection control part 32, a recording part 33, and a timer part 34. The service module 12 is configured to include a receiving destination 41.

The transmitting source 31 is configured to transmit a communication to perform the communication. The simultaneous connection control part 32 is configured to determine whether to execute a communication with respect to which simultaneous connection needs to be controlled, to wait for the communication, or to cancel the communication by utilizing information such as an execution status of the communication. The recording part 33 is configured to record information necessary for performing a simultaneous connection control process. The timer part 34 is configured to count a certain (predetermined) time. The timer part 34 is utilized for allowing a process of determining whether to execute the communication, to wait for the communication, or to cancel the communication to wait for a predetermined time. Further, the receiving destination 41 is configured to receive a communication to perform the communication.

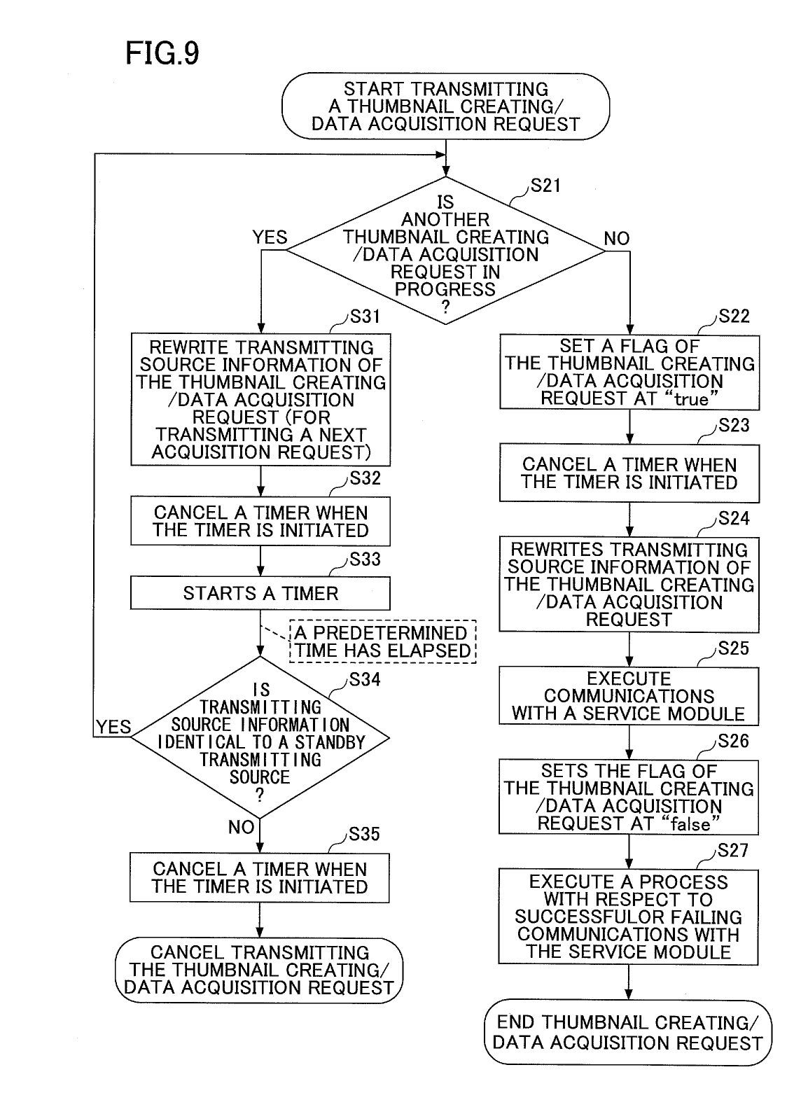

FIG. 9 is a flowchart illustrating an example of a simultaneous connection control process. The flowchart of FIG. 9 starts when a thumbnail creating/data acquisition request is received. The thumbnail creating/data acquisition request may be generated by initializing (updating) a screen or scrolling a screen. The thumbnail creating/data acquisition request corresponds to the thumbnail creating request and the image data acquisition request. Further, a thumbnail acquisition flag (a flag of the thumbnail creating/data acquisition request) recorded in the recording part 33 and a transmitting source of a thumbnail acquisition (the thumbnail creating/data acquisition request) are used as common information in the flowchart of FIG. 9.

The simultaneous connection control part 32 initiates a process of the flowchart of FIG. 9 when receiving the thumbnail creating/data acquisition request from the transmitting source 31. In step S21, the simultaneous connection control part 32 determines whether another thumbnail creating/data acquisition request is in progress.

When the other thumbnail creating/data acquisition request is not in progress, the simultaneous connection control part 32 proceeds with step S22 to continue to perform the process. On the other hand, when the other thumbnail creating/data acquisition request is in progress, the simultaneous connection control part 32 proceeds with step S31 to cause the process to be in a standby mode.

When the other thumbnail creating/data acquisition request is not in progress, the simultaneous connection control part 32 proceeds with step S22 to set the flag of the thumbnail creating/data acquisition request at “true”.

In step S23, when a timer is initiated by another thumbnail creating/data acquisition request, the simultaneous connection control part 32 cancels the timer. In step S24, in order to indicate that the thumbnail creating/data acquisition request is already in progress, the simultaneous connection control part 32 rewrites transmitting source information of the thumbnail creating/data acquisition request with that of another thumbnail creating/data acquisition request for executing the communications. The transmitting source information is unique to each of the thumbnail creating/data acquisition requests. In step S25, the transmitting source 31 of the UI module 11 executes communications for performing the thumbnail creating/data acquisition request to the receiving destination 41 of the service module 12.

When the communications for performing the thumbnail creating/data acquisition request have completed, the simultaneous connection control part 32 proceeds with step S26. In step S26, the simultaneous connection control part 32 sets the flag of the thumbnail creating/data acquisition request at “false” for indicating that the transmitting thumbnail creating/data acquisition request is not in progress. The simultaneous connection control part 32 then proceeds with step S27 to execute a process with respect to a result of either successful or failing communications for transmitting the thumbnail creating/data acquisition request to complete the thumbnail creating/data acquisition request.

On the other hand, when another thumbnail creating/data acquisition request is in progress, the simultaneous connection control part 32 executes a process for temporarily allowing the thumbnail creating/data acquisition request to be in a standby mode. The simultaneous connection control part 32 then proceeds with step S31 to rewrite transmitting source information of the thumbnail creating/data acquisition request with that of the standby thumbnail creating/data acquisition request for performing another thumbnail creating/data acquisition request after the currently being executed communications.

In step S32, when a timer is created by another thumbnail creating/data acquisition request, the simultaneous connection control part 32 cancels the timer. In step S33, the simultaneous connection control part 32 initiates the timer and waits for a predetermined time (e.g., 1 ms). After the predetermined time has elapsed, the simultaneous connection control part 32 determines whether the transmitting source information of the thumbnail creating/data acquisition request is identical to that of the standby thumbnail creating/data acquisition request in step S34.

When the transmitting source information of the thumbnail creating/data acquisition request is identical to that of the standby thumbnail creating/data acquisition request, the simultaneous connection control part 32 returns to step S21 and proceeds with step S21. On the other hand, when the transmitting source information of the thumbnail creating/data acquisition request is not identical to that of the standby thumbnail creating/data acquisition request, in step S35 the simultaneous connection control part 32 cancels the timer that is initiated in step S33 to cancel the thumbnail creating/data acquisition request.

The flowchart of FIG. 9 presupposes prioritizing the subsequently transmitted thumbnail creating/data acquisition request. The present embodiment indicates an example of a process necessary for displaying a thumbnail; however, the present embodiment also manages a case where the once required thumbnail is not required by user's scrolling operations and a new thumbnail is required.

Note that the flowchart of FIG. 9 illustrates an example of the process using the flag of the thumbnail creating/data acquisition request and the transmitting source information of the thumbnail creating/data acquisition request; however, the flag of the thumbnail creating/data acquisition request may be omitted from the process. When the flag of the thumbnail creating/data acquisition request is omitted from the process, the transmitting source information of the thumbnail creating/data acquisition request may be configured to serve as the flag of the thumbnail creating/data acquisition request.

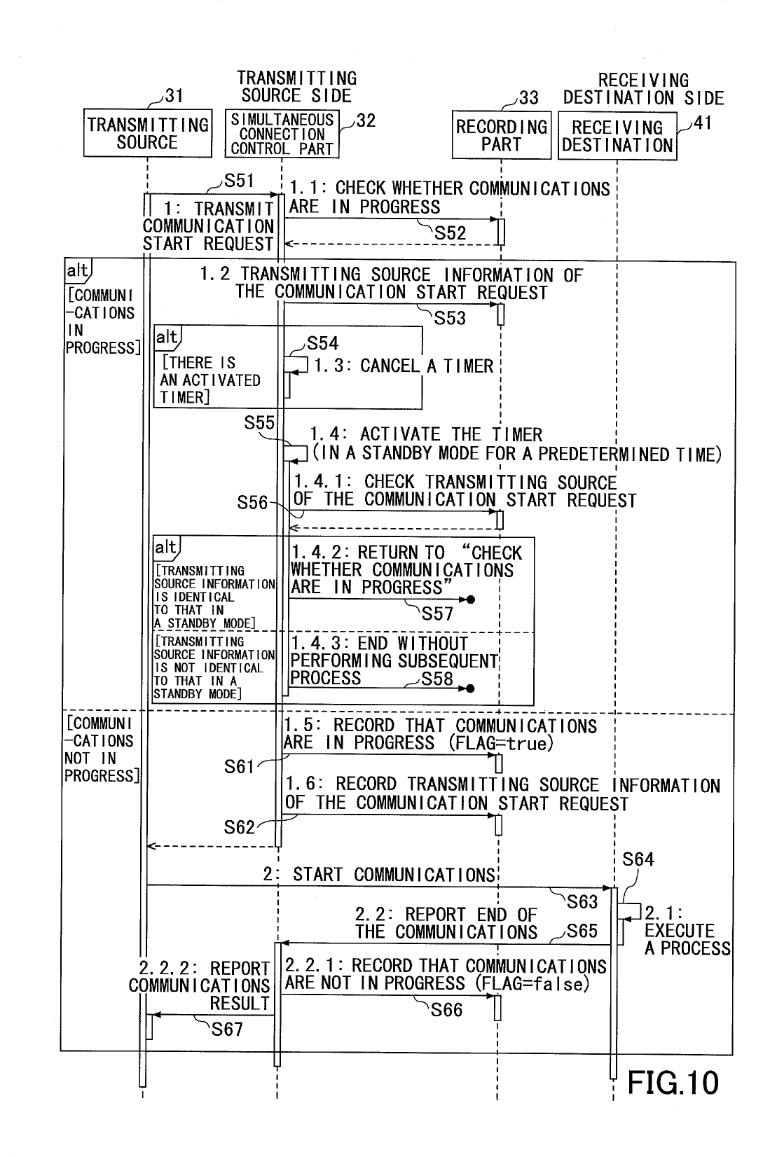

FIG. 10 is a sequence diagram illustrating an example of a simultaneous connection control process. Note that the sequence diagram illustrated in FIG. 10 may be divided into three sets of the processes; that is the process including steps S51 to S52, the process including steps S53 to S58, and the process including steps S61 to S67. Hence, the process including steps S51 to S52, the process including steps S53 to S58, and the process including steps S61 to S67 are separately illustrated below.

Steps S51 and S52 represent an example of a process when a communication start request is generated. In step S51, the transmitting source 31 transmits the communication start request to the simultaneous connection control part 32. In step S52, in order to determine whether another transmitting source is currently engaged in communications, the simultaneous connection control part 32 transmits to the recording part 33 a request for a value of a flag indicating whether the communications are in progress.

The simultaneous connection control part 32 determines whether the communications are in progress based on the value of the flag indicating whether the communications are in progress. When the communications are in progress, the simultaneous connection control part 32 performs the process including steps S53 to S58. On the other hand, when the communications are not in progress, the simultaneous connection control part 32 performs the process including steps S61 to S67.

The process including steps S53 to S58 is an example of a process where execution of the communications is temporarily allowed to be in a standby mode. In step S53, in order to temporarily allow execution of the communications to be in a standby mode, the simultaneous connection control part 32 records in the recording part 33 information on the transmitting source 31 that has transmitted the communication start request as transmitting source information of the communication start request.

When there is an already activated timer, the simultaneous connection control part 32 cancels the timer in step S54. In step S55, the simultaneous connection control part 32 activates a timer to be in a standby mode for a predetermined time. After the predetermined time has elapsed, the simultaneous connection control part 32 checks the transmitting source information of the communication start request currently recorded in the recording part 33 in step S56.

When the transmitting source information of the communication start request currently recorded in the recording part 33 is identical to that of the communication start request in an initial standby mode, in step S57 the simultaneous connection control part 32 returns to step S52. On the other hand, when the transmitting source information of the communication start request currently recorded in the recording part 33 is not identical to that of the communication start request in an initial standby mode, in step S58 the simultaneous connection control part 32 ends the process without performing a subsequent process to cancel the communication start request.

The process including steps S61 to S67 is an example of a process for executing the communications. In step S61, the simultaneous connection control part 32 requests the recording part 33 to set the flag indicating whether the communications are in progress at “true” to record that the communications are in process for executing the communications.

In step S62, the simultaneous connection control part 32 requests the recording part 33 to record information on the transmitting source 31 that is ready to perform communications as transmitting source information of the communication start request. The simultaneous connection control part 32 reports to the transmitting source 31 that the flag indicating whether the communications are in progress and the transmitting source information of the communication start request have been recorded.

In step S63, the transmitting source 31 starts communicating with respect to the receiving destination 41. The receiving destination 41 that has received the communications executes a process determined in step S64. After the process in step S64, the receiving destination 41 reports the end of the communications to the simultaneous connection control part 32.

When the simultaneous connection control part 32 receives the report indicating the end of the communications, the simultaneous connection control part 32 requests the recording part 33 to set the flag indicating whether the communications are in progress at “false” to record that the communications are not in process in step S66. Simultaneously, the simultaneous connection control part 32 reports a result of the communications to the transmitting source 31 in step S67.

### SUMMARY

In the related art GUI applications, the following factors may be improved. For example, when an additional communication is generated after two communications are generated from the UI module 11 to request the service module 12 to perform processes that take a long time to complete, the last communication may be subject to time out or performed inaccurately.

Thus, the present embodiment is configured to perform a simultaneous connection control process with respect to one or more types of “communications that take a long time to complete”, such as a thumbnail creating request and an image data acquisition request.

Hence, in the communications from the transmitting source to the receiving destination, the processes or communications that do not take a long time to complete may be prevented from being timed out by controlling the number of communications that may be generated simultaneously among one or more types of communications that take a long time to complete. Further, according to the present embodiment, in the communications from the transmitting source to the receiving destination, the processes or communications that do not take a long time to complete may be prevented from being performed inaccurately by controlling the number of communications that may be generated simultaneously among one or more types of communications that take a long time to complete.

Moreover, according to the present embodiment, the communications concentration resulting in communication errors may be relaxed by controlling the number of communications that may be generated simultaneously among one or more types of communications that take a long time to complete before the actual communications from the transmitting source to the receiving destination are generated. In addition, the present embodiment may be applied to plural types of communications for requesting the processes that take a long time to complete.

According to an aspect of the embodiment, it may be possible to control the number of communications that take a long time to complete.

The present invention is not limited to the embodiments specifically disclosed above, and various alterations or modifications may be made without departing from the spirit and the scope of the invention.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority or inferiority of the invention. Although the embodiment of the present invention has been described in detail, it should be understood that various changes, substitutions, and alterations could be made hereto without departing from the spirit and scope of the invention.

The present application is based on and claims the benefit of priority of Japanese Priority Application No. 2013-084731 filed on Apr. 15, 2013, the entire contents of which are hereby incorporated by reference.

What is claimed is:

1. A non-transitory computer-readable recording medium storing a program, which when executed by a processor, causes a computer to serve as components of the computer, the components, comprising:
a recording unit configured to record information indicating whether a communication requesting a first process is being performed in a transmitting source, the transmitting source performing the communication requesting the first process that takes a long time to complete and a communication requesting a second process that takes a time shorter than that of the first process; and
a simultaneous connection control unit configured to control a number of communications requesting the first process by referring to the information stored in the recording unit such that at least one communication requesting the second process is performed in the transmitting source when a number of simultaneously occurring communications allowed to be performed is restricted in the transmitting source of the communications and a receiving destination.

2. The non-transitory computer-readable recording medium as claimed in claim 1, wherein
the simultaneous connection control unit determines whether a different communication requesting the first process is being performed by referring to the information stored in the recording unit before performing the communication requesting the first process, and wherein when the simultaneous connection control unit determines that the different communication requesting the first process is not being performed, the simultaneous connection control unit updates the information stored in the recording unit with new information indicating that the communication requesting the first process is currently being performed, and subsequently causes the transmitting source to perform the communication requesting the first process.

3. The non-transitory computer-readable recording medium as claimed in claim 2, wherein
when the simultaneous connection control unit determines that the different communication requesting the first process is currently being performed, the simultaneous connection control unit causes the communication requesting the first process to be in a standby mode until the different communication ends.

4. The non-transitory computer-readable recording medium as claimed in claim 3, wherein
the recording unit further stores transmitting source information indicating the communication requesting the first process being in a standby mode, and wherein
when the simultaneous connection control unit determines that the different communication requesting the first process is currently being performed, the simultaneous connection control unit rewrites the transmitting source information stored in the recording unit with new transmitting source information indicating that a new communication requesting the first process serves as the communication requesting the first process to be in a standby mode.

5. The non-transitory computer-readable recording medium as claimed in claim 4, the components further comprising:
a timer unit configured to count a predetermined time, wherein
when the timer unit counts the predetermined time after the simultaneous connection control unit rewrites the transmitting source information stored in the recording unit with the new transmitting source information indicating that the new communication requesting the first process serves as the communication requesting the first process to be in a standby mode,
the simultaneous connection control unit cancels a communication requesting the first process to be in a standby mode that is not recorded in the transmitting source information, among the communications requesting the first process in a standby mode.

6. The non-transitory computer-readable recording medium as claimed in claim 1, wherein
the communication requesting the first process includes a communication performing a thumbnail creating request, and
a communication performing a thumbnail image data acquisition request.

7. A communication control method executed by a computer, the communication control method comprising:
recording in a recording unit information indicating whether a communication requesting a first process is being performed in a transmitting source, the transmitting source performing the communication requesting the first process that takes a long time to complete and a communication requesting a second process that takes a time shorter than that of the first process; and
controlling a number of communications requesting the first process by referring to the information stored in the recording unit such that at least one communication requesting the second process is performed in the transmitting source when a number of simultaneously occurring communications allowed to be performed is restricted in the transmitting source of the communications and a receiving destination.
